(19) United States
(12) Patent Application Publication
(10) Pub. No.: US 2019/0377823 A1
(43) Pub. Date: Dec. 12, 2019

(54) UNSUPERVISED CLASSIFICATION OF DOCUMENTS USING A LABELED DATA SET OF OTHER DOCUMENTS

(71) Applicant: ELEMENT AI INC., Montreal (CA)

(72) Inventors: Thomas BOQUET, Montreal (CA); Francis DUPLESSIS, Montreal (CA)

(21) Appl. No.: 16/002,811

(22) Filed: Jun. 7, 2018

(51) Int. Cl. G06F 17/30; G06N 3/08

(52) U.S. Cl. CPC G06F 17/30598; G06N 3/08; G06F 17/30011

(57) ABSTRACT

Systems and methods for associating an unknown subject document with other documents based on known features of the other documents. The subject document is passed through a feature extraction module, which represents the features of the subject document as a numeric vector having n dimensions. A matching module receives that vector and reference data. The reference data is pre-divided into n groupings, with each grouping corresponding to at least one specific feature. The matching module compares the features of the subject document to features of the reference data and determines a matching grouping for the subject document. The subject document is then associated with that matching grouping.

### TECHNICAL FIELD

The present invention relates to the classification of documents. More specifically, the present invention relates to systems and methods for unsupervised classification of documents using other previously classified documents.

### BACKGROUND

Accurate document classification is a long-standing problem in information science. Traditional document classification has been performed by librarians and consensus: the Dewey Decimal system, for instance, is an example of a well-established classification scheme for library materials. However, manual classification requires a significant amount of human effort and time, which may be better spent on more critical tasks, particularly as technological advancements have increased the volume of documents that require classification.

An average human classifier, reading at 250 words per minute, would require 16,000 hours (roughly 1.8 years) simply to read a set of 400,000 news articles. Classifying those articles would require even more time, and becomes unwieldy when there are many possible features/topics/sub-topics. Moreover, the human-generated results may contain substantial inaccuracies, as these human classifiers would struggle to sustain their focus for the needed time, and to analyze each subject document for more than a few features at once.

As a result, many techniques for unsupervised classification have been developed (“unsupervised classification” referring to document classification that is not overseen by a human). However, such techniques are typically computationally expensive and time-intensive. Current state-of-the-art techniques for unsupervised classification require access to the entire dataset at all times, meaning that enormous datasets may need to be searched for each operation.

Further, conventional techniques for unsupervised classification are often based on text documents only, and do not necessarily generalize to non-textual input documents. Additionally, as many of these techniques revolve around word frequency and what can be called “next-word probability” (i.e., the likelihood that one word will follow another known word), they can miss important contextual factors.

There is a need for less costly and more scalable systems and methods for document classification. Preferably, these systems and methods would operate without supervision and, rather than extracting individual terms, extract higher-level features and topics from each document.

### SUMMARY

The present invention provides systems and methods for associating an unknown subject document with other documents based on known features of the other documents. The subject document is passed through a feature extraction module, which represents the features of the subject document as a numeric vector having n dimensions. A matching module receives that vector and reference data. The reference data is pre-divided into n groupings, with each grouping corresponding to at least one specific feature. The matching module compares the features of the subject document to features of the reference data and determines a matching grouping for the subject document. The subject document is then associated with that matching grouping.

In a first aspect, the present invention provides a method for determining other documents to be associated with a subject document, the method comprising:
(a) passing said subject document through a feature extraction module to thereby produce a numeric vector representation of features of said subject document, said vector representation having n dimensions;
(b) positioning a new point in an n-dimensional space based on said vector representation, wherein said n-dimensional space contains a plurality of reference points, wherein each of said other documents corresponds to a single one of said plurality of reference points, and wherein said plurality of reference points is divided into a plurality of groupings, each grouping corresponding to at least one specific feature of said other documents;
(c) determining a matching grouping from said plurality of groupings for said subject document based on at least one predetermined criterion; and
(d) associating said subject document with said matching grouping.

In a second aspect, the present invention provides a system for determining other documents to be associated with a subject document, the system comprising:
a feature extraction module for producing a numeric vector representation of features of said subject document;
reference data, said reference data comprising numeric vectors, wherein each of said other documents corresponds to a single one of said numeric vectors, and wherein said reference data is grouped into a plurality of groupings, each grouping corresponding to at least one specific feature of said other documents;
a matching module for determining a matching grouping from said plurality of groupings for said subject document, said matching grouping being determined based on at least one predetermined criterion, wherein said system associates said subject document with said matching grouping.

In a third aspect, the present invention provides non-transitory computer-readable media having stored thereon computer-readable and computer-executable instructions that, when executed, implements a method for determining other documents to be associated with a subject document, the method comprising:
(a) passing said subject document through a feature extraction module to thereby produce a numeric vector representation of features of said subject document, said vector representation having n dimensions;
(b) positioning a new point in an n-dimensional space based on said vector representation, wherein said n-dimensional space contains a plurality of reference points, wherein each of said other documents corresponds to a single one of said plurality of reference points, and wherein said plurality of reference points is divided into a plurality of groupings, each grouping corresponding to at least one specific feature of said other documents;
(c) determining a matching grouping from said plurality of groupings for said subject document based on at least one predetermined criterion; and
(d) associating said subject document with said matching grouping.

### BRIEF DESCRIPTION OF THE DRAWINGS

The present invention will now be described by reference to the following figures, in which identical reference numerals refer to identical elements and in which:

FIG. 1 is a schematic diagram detailing one aspect of the present invention;

FIG. 2A is a representative image that may be used by the present invention, in some embodiments;

FIG. 2B is another representative image that may be used by the present invention, in some embodiments;

FIG. 2C is another representative image that may be used by the present invention, in some embodiments; and

FIG. 3 is a flowchart detailing the steps in a method according to another aspect of the present invention.

### DETAILED DESCRIPTION

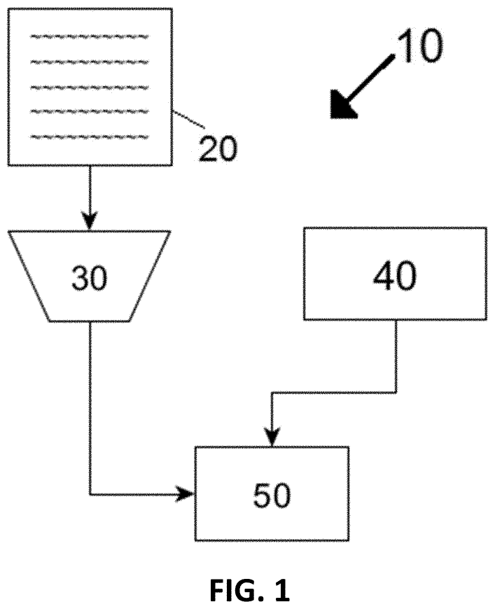

Referring to FIG. 1, a schematic diagram illustrating one aspect of the present invention is presented. In the system 10, a subject document 20 is passed through a feature extraction module 30. The feature extraction module 30 is associated with a matching module 50. Reference data 40 is also associated with the matching module 50.

The feature extraction module 30 extracts features of the subject document 20 and produces a numeric vector representation of the subject document 20 based on those features, with the vector having n dimensions. The feature extraction module 30 then passes that vector representation to a matching module 50.

The matching module 50 also receives reference data 40, representing other previously classified documents with known features. The reference data 40 is previously divided into groupings, with each grouping corresponding to at least one specific feature of the documents within that grouping.

The matching module 50 then compares the vector representation of the features of the subject document 20 to features of the reference data 40 to determine a matching grouping for the subject document 20. The subject document 20 is then associated with that matching grouping.

In one embodiment, a neural network can be used as the feature extraction module 30. Such a neural network would be trained to extract specific features that the user wishes to identify. Note therefore the features to be extracted may vary depending on context. For instance, a large set of news articles broadly grouped as “sports news” may be classified using keywords such as “hockey”, “basketball”, and “soccer”. As another example, where the present invention is used to classify images, important features and themes may include “face” or “tree”.

It should be noted that the identified features may be thought of as “keywords”, “subjects”, “topics”, “themes”, “subthemes”, “aspects”, or any equivalent term suitable for the context. References herein to any of such terms should be taken to include all such terms. Similarly, the subject document 20 can be any kind of document with any number of dimensions. For instance, one-dimensional “documents” may include text, time series data, and/or sounds, and two-dimensional documents may comprise natural images, spectrograms, satellite images. Subject documents in three-dimensions may include videos and/or medical imaging volumes, and four-dimensional subject documents may include videos of medical imaging volumes, as well as video game data. Thus, the terms “article” and “image”, as used in the examples herein, should not be construed as limiting the term “document”. It should be noted, however, that as the dimensions of the input documents increase, and/or as the size of the set of input documents increases, extracting appropriate high-level features for each document set may become more difficult.

Additionally, it should be evident that the feature lists described above are merely exemplary and that these are simplified for ease of explanation. The present invention is capable of handling far more than two or three broad features at one time. Current implementations of the present invention can deal with 512 features simultaneously and the present invention is in no way restricted by the current implementations. Any restrictions on the number of features (number of dimensions) should not be construed as limiting the scope of the invention.

The neural network, or other feature extraction module 30, outputs a numeric vector representation of the subject document. Each coordinate within that numeric vector representation corresponds to one of the possible features. In some implementations, each coordinate can be a numeric value indicating the probability that the subject document has that specific feature. In such an implementation, the coordinates may be bounded between, for instance, 0 and 1, or 0 and 100. In other implementations, however, each coordinate may reflect a non-probabilistic correspondence to its associated feature.

To re-use the “sports articles” example mentioned above (again, noting that this is a simplification for exemplary purposes), a subject article discussing a hockey game might be represented as a numeric vector such as [0.8, 0.1, 0.1], in a three-dimensional space defined by the coordinate system [hockey, basketball, soccer]. This vector suggests that there is an 80% chance that the article relates to hockey and only a 10% chance that the article relates to either basketball or soccer.

In some implementations, outlier documents in the data set are sent to a human reviewer. Such outlier documents are documents that do not match well with any known features. The system will provide an outlier document and its closest feature matches to the human reviewer, who can select a better feature match if necessary. The results of this human review can be fed back to the system and incorporated into later classifications.

Note that a separate feature extraction module 30 is preferred for each classification problem, so that appropriate features may be determined in context. It would be impractical to attempt, for instance, to classify images of a forest using a feature extraction module previously trained to classify business-news articles.

It should additionally be noted that the feature extraction module 30 can be initially trained on a similar or higher-level classification problem than the classification problem to be solved. Thus, the reference data points 40 are already populated and grouped when they are passed to the feature extraction module 30.

The numeric vector is then passed to a matching module 50. The matching module 50 compares the vector to a pre-existing set of reference data 40. The reference data points (numeric vectors each having n dimensions) are based on reference documents with known features.

The reference data points 40, received by the matching module 50, are divided into a plurality of groupings, such that each grouping corresponds to at least one specific feature. In the “sports articles” example above, reference data would be divided into three or more groupings, including “hockey”, “basketball”, and “soccer”.

In some implementations, “approximate nearest neighbour algorithms” can be used to divide the reference data into groupings. Various approximate nearest neighbour algorithms are well-known in computer science and data analysis (see, for instance, Indyk & Motwani, “Approximate Nearest Neighbors: Towards Removing the Curse of Dimensionality”, Proceedings of the thirtieth annual ACM symposium on Theory of Computing (1998), the complete text of which is hereby incorporated by reference).

It should be clear that none of the data points are moved or transformed during the grouping process. All of the grouping information is a layer of metadata that has no direct connection to or impact on the original data set. Other models for dividing data sets into groupings are known in the art, including hierarchical and distributional models.

The matching module 50 may consider multiple factors when determining a matching grouping for a subject document, based on the grouped reference data. In particular, in some embodiments, the matching module 50 can consider the distance between the subject document's numeric vector representation and the centroids of reference groupings.

The matching module 50 may also consider factors beyond the distance to grouping centroids. Such other factors include, for example, publication dates or date ranges: more recent news articles dealing with sports or politics may be grouped separately from older articles on the same topics. Other factors (such as, for instance, author, region, publication, etc.) may also be used by the matching module 50 in determining a matching grouping for the subject grouping, according to the context. Any variable that is continuously available in the data set (i.e., separately available for each document in the data set) can be used to modify or weight the results of the feature extraction module.

For clarity, these other factors are present in the original data set and are not treated as features within the numeric vectors. Any modification of the results of the feature extraction module occurs post-feature extraction and is performed by the matching module 50.

To increase comparison accuracy and to reduce overfitting, the present invention preferably uses a reference data set containing around 1,000 reference data points. The present invention results in significant time-savings compared to manual and/or typical text-analysis document classification methods, and additionally provides greater classification accuracy than the prior methods.

In testing, one implementation of the present invention classified a text input set of 400,000 subject articles using 512 dimensions, classifying each document into: one theme from a possible 25 themes; multiple subthemes from a possible 200 subthemes; and multiple regions from a possible 24 regions. These results were achieved within 10 ms±3 ms. It should be clear that, in the testing implementation, each “theme”, “subtheme”, and “region” was a separate extracted feature. It is predicted that the present invention could classify a set of 10,000,000 subject documents within 100 milliseconds.

A further advantage of the present invention over prior art methods arises when the present invention is used to classify images. Artificially intelligent image classification is typically performed in a pixel-space. That is, typical machine classifiers for images produce a numeric vector representation wherein the vector coordinates correspond to pixels, or pixel regions, of each image. Although such an approach allows for accurate classification of images that are positionally similar, classification based on pixel-space representations can misassociate images that are substantively similar but positionally distinct. (Again, of course, the term “images” as used here can be generalized to any kind of multi-dimensional input data.)

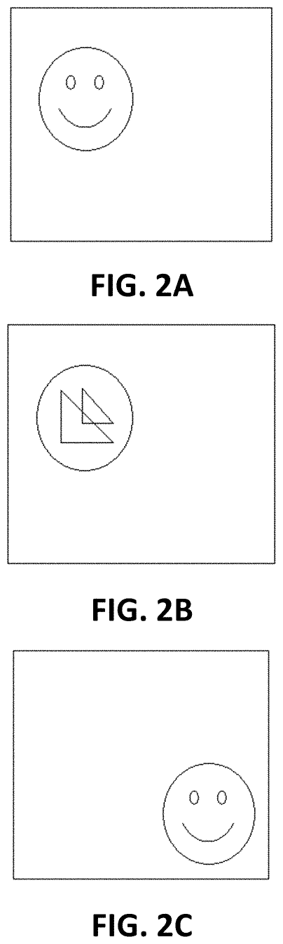

As an example, consider FIGS. 2A, 2B, and 2C. FIG. 2A shows a stylized face in the top left of the image, and nothing in the bottom right. FIG. 2B shows a circle in the same location as FIG. 2A's stylized face, but shows a pair of triangles within the circle, rather than that face. FIG. 2C, lastly, has the same stylized face as FIG. 2A, but here the face is shown in the bottom right of the image, and the top left of the image is empty. Because typical pixel-space classifiers merely consider positional information, a typical classifier would conclude that FIGS. 2A and 2B are more similar to each other than are FIGS. 2A and 2C, notwithstanding the visibly distinct subject matter.

The present invention, on the other hand, compares images based on substance rather than pixel density. Examining FIGS. 2A, 2B, and 2C, and supposing the classification problem to be “separate all images containing a face from all images not containing a face”, a feature extraction module may be trained to identify the features “eyes”, “mouth”, and “circle”. (Again, it should be evident that this is a simplification for exemplary purposes.) The vector representing FIG. 2A would then have comparatively high values in all three coordinates, as FIG. 2A has a circle, (stylized) eyes and a (stylized) mouth. The vector representing FIG. 2B, on the other hand, would have comparatively low values in the “eyes” and “mouth” coordinates but a higher value in “circle”. Then, taking FIGS. 2A and 2B to be the reference data for this classification problem, groupings called “face” and “not face” could be defined: the “face” grouping containing the representation of FIG. 2A, and the “not face” grouping containing the representation of FIG. 2B.

FIG. 2C, the new subject document in this example, would then be passed through the feature extraction module. The vector representation of FIG. 2C, like that of FIG. 2A, would have comparatively high values for all three features. Thus, when the matching module receives that vector and the reference vectors, the matching module would determine that the vector representation of FIG. 2C is more similar to that of FIG. 2A than to FIG. 2b, and would thus associate FIG. 2C with FIG. 2A. Both images containing a face would be grouped together in the “face” grouping, and only FIG. 2B would remain in the “not face” grouping.

Other applications of the present invention include reverse searches. That is, for instance, if a user knows that a certain phrase is contained in a reference data set, but does not know precisely which document that phrase comes from, they can enter the phrase into the system. Depending on the granularity of the grouping model used and the number of features, the system may return a high-level grouping or a more granular grouping, or even, in some implementations, a specific document.

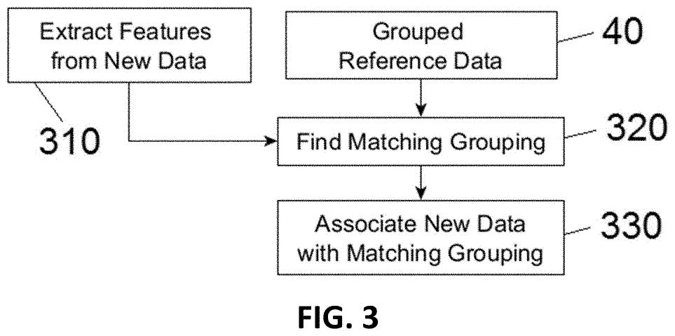

FIG. 3 is a flowchart detailing the steps in a method according to one aspect of the invention. At step 310, the features of a subject document are extracted by a feature extraction module, resulting in a numeric vector representation of the subject document. That numeric vector representation and the grouped reference data 40 is passed to the matching module. At step 320, the matching module determines the matching grouping for the subject document, and at step 330, the subject document is associated with that matching grouping. As discussed above, the matching module typically determines the matching grouping based on a distance between the new vector representation and a centroid of each grouping. This matching process is performed for every new subject document. Thus, the present invention can automatically classify large groups of subject documents without human intervention.

In one aspect, the present invention can be seen as the use of a neural encoder with a proxy task related to the task the one seeks to complete. Thus, the result is a fast unsupervised classification technique that takes into account the entire past and which uses post processing methods to refine the results.

Since unsupervised classification is, most of the time, computationally intensive, one aspect of the invention uses an already existing fast nearest-neighbours retrieval technique to perform classification. The results are then refined by weighting the contribution of each neighbour using non-parametric methods. As one example, the contribution of neighbours is weighted with respect to the recency of the document. In one variant, a neural network may be used to output a weight for the examples.

In another aspect, the present invention uses supervised training to learn a meaningful space as a proxy to a problem that one seeks to solve. A closely related problem, which is higher-level than the problem sought to be solved, is used to build the neural encoder that will yield a suitable feature space.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for determining other documents to be associated with a subject document, the method comprising:
(a) passing said subject document through a feature extraction module to thereby produce a numeric vector representation of features of said subject document, said vector representation having n dimensions;
(b) positioning a new point in an n-dimensional space based on said vector representation, wherein said n-dimensional space contains a plurality of reference points, wherein each of said other documents corresponds to a single one of said plurality of reference points, and wherein said plurality of reference points is divided into a plurality of groupings, each grouping corresponding to at least one specific feature of said other documents;
(c) determining a matching grouping from said plurality of groupings for said subject document based on at least one predetermined criterion; and
(d) associating said subject document with said matching grouping.

2. The method of claim 1, wherein said feature extraction module is a trained neural network for extracting features.

3. The method of claim 1, wherein each grouping is based on a distance between each of said plurality of reference points within said each grouping and a centroid of each grouping.

4. The method of claim 1, wherein said at least one predetermined criterion includes a maximum distance, such that a distance between said new point and a centroid of said matching cluster is smaller than said maximum distance.

5. The method of claim 1, wherein said at least one predetermined criterion includes a date range, such that a date of said subject document is within said date range.

6. The method of claim 1, wherein said at least one predetermined criterion includes both:
a maximum distance, such that a distance between said new point and a centroid of said matching cluster is smaller than said maximum distance; and
a date range, such that a date of said subject document is within said date range.

7. The method of claim 1, wherein said subject document comprises at least one of:
text;
image;
text and at least one image;
video data;
audio data;
medical imaging data;
unidimensional data; and
multi-dimensional data.

8. A system for determining other documents to be associated with a subject document, the system comprising:
a feature extraction module for producing a numeric vector representation of features of said subject document;
reference data, said reference data comprising numeric vectors, wherein each of said other documents corresponds to a single one of said numeric vectors, and wherein said reference data is grouped into a plurality of groupings, each grouping corresponding to at least one specific feature of said other documents;
a matching module for determining a matching grouping from said plurality of groupings for said subject document, said matching grouping being determined based on at least one predetermined criterion,
wherein said system associates said subject document with said matching grouping.

9. The system of claim 8, wherein said feature extraction module is a trained neural network for extracting features.

10. The system of claim 8, wherein each grouping in said plurality of groupings is determined based on a distance between each of said numeric vectors within said each grouping and a centroid of each grouping.

11. The system of claim 8, wherein said at least one predetermined criterion is a maximum distance, such that a distance between said numeric vector representation and a centroid of said matching cluster is smaller than said maximum distance.

12. The system of claim 8, wherein said at least one predetermined criterion is a date range, such that a date of said subject document is within said date range.

13. The system of claim 8, wherein said at least one predetermined criterion includes both:
a maximum distance, such that a distance between said numeric vector representation and a centroid of said matching cluster is smaller than said maximum distance; and
a date range, such that a date of said subject document is within said date range.

14. The system of claim 8, wherein said subject document comprises at least one of:
text;
image;
text and at least one image;
video data;
audio data;
medical imaging data;
unidimensional data; and
multi-dimensional data.

15. Non-transitory computer-readable media having stored thereon computer-readable and computer-executable instructions that, when executed, implements a method for determining other documents to be associated with a subject document, the method comprising:
(a) passing said subject document through a feature extraction module to thereby produce a numeric vector representation of features of said subject document, said vector representation having n dimensions;
(b) positioning a new point in an n-dimensional space based on said vector representation, wherein said n-dimensional space contains a plurality of reference points, wherein each of said other documents corresponds to a single one of said plurality of reference points, and wherein said plurality of reference points is divided into a plurality of groupings, each grouping corresponding to at least one specific feature of said other documents;
(c) determining a matching grouping from said plurality of groupings for said subject document based on at least one predetermined criterion; and
(d) associating said subject document with said matching grouping.

16. The computer-readable media of claim 15, wherein said feature extraction module is a trained neural network for extracting features.

17. The computer-readable media of claim 15, wherein each grouping is based on a distance between each of said plurality of reference points within said each grouping and a centroid of each grouping.

18. The computer-readable media of claim 15, wherein said at least one predetermined criterion includes at least one of:
a maximum distance, such that a distance between said new point and a centroid of said matching cluster is smaller than said maximum distance; and
a date range, such that a date of said subject document is within said date range.

19. The computer-readable media of claim 15, wherein said at least one predetermined criterion includes both:
a maximum distance, such that a distance between said new point and a centroid of said matching cluster is smaller than said maximum distance; and
a date range, such that a date of said subject document is within said date range.

20. The computer-readable media of claim 15, wherein said subject document comprises at least one of:
text;
image;
text and at least one image;
video data;
audio data;
medical imaging data;
unidimensional data; and
multi-dimensional data.
